(19) United States
(12) Patent Application Publication
(10) Pub. No.: US 2008/0090593 A1
(43) Pub. Date: Apr. 17, 2008

(54) Method and related apparatus for enhancing paging efficiency in a wireless communications system

(75) Inventor: Yu-Chih Jen, Taipei City (TW)

Correspondence Address: BIRCH STEWART KOLASCH & BIRCH, PO BOX 747, FALLS CHURCH, VA, 22040-0747, US

(73) Assignee: Innovative Sonic Limited, Tortola (VG)

(21) Appl. No.: 11/907,485

(22) Filed: Oct. 12, 2007

Related U.S. Application Data
(60) Provisional application No. 60/829,151, filed on Oct. 12, 2006.

(51) Int. Cl. H04Q 7/20

(52) U.S. Cl. 455/458

(57) ABSTRACT

A method for enhancing paging efficiency in a wireless communications system includes a user equipment of the wireless communications system receiving a service provided by a Multimedia Broadcast Multicast Service dedicated cell, and a network of the wireless communications system outputting a paging message for paging the user equipment in at least one cell of a tracking area determined according to a result of a tracking area update procedure of the user equipment when the network receives a terminating call corresponding to the user equipment.

### CROSS REFERENCE TO RELATED APPLICATIONS

This application claims the benefit of U.S. Provisional Application No. 60/829,151, filed on Oct. 12, 2006 and entitled “Method and Apparatus for realizing efficient and uninterrupting paging in LTE MBMS dedicated cell”, the contents of which are incorporated herein by reference.

### BACKGROUND OF THE INVENTION

1. Field of the Invention

The present invention relates to a method and related apparatus for enhancing paging efficiency in a wireless communications system, and more particularly to a method and related apparatus for avoiding transmission break and packet loss in a wireless communications system.

2. Description of the Prior Art

Multimedia Broadcast Multicast Service (MBMS) is a point-to-multipoint bearer service, utilized for enhancing multimedia functions in the 3G mobile telecommunications system, established on an existing network architecture of the Universal Mobile Telecommunications System (UMTS). MBMS utilizes Internet Protocol (IP) packets as a medium, so that MBMS allows a single source entity to transmit data to multiple user entities simultaneously.

Long Term Evolution wireless communications system (LTE system), an advanced high-speed wireless communications system established upon the 3G mobile telecommunications system, supports only packet-switched transmission, and tends to combine Radio Link Control (RLC) layer and Medium Access Control (MAC) layer into the same communication layer, so that the system structure becomes simple. Now, parts of the LTE structure are under Technical Report (TR) stage, meaning that the related protocol specifications are not finished. Regarding to the current LTE structure, the LTE wireless communications system also supports MBMS, in order to enhance multimedia functions.

In the prior art, the LTE wireless communications system supports two different cells for distributing MBMS services i.e. MBMS dedicated cell and mixed cell. An MBMS mixed cell can provide both MBMS services and non-MBMS services (or unicast services) while an MBMS dedicated cell, where uplink and unicast data transfer are not supported, is a cell dedicated to MBMS transmissions.

Since MBMS may be provided on a frequency layer dedicated to MBMS (set of cells dedicated to MBMS transmission i.e. set of “MBMS dedicated cells”) as well as on a frequency layer shared with non-MBMS services (set of cells supporting both unicast and MBMS transmissions i.e. set of “mixed cells”), a User Equipment (UE) may be equipped with dual receiver corresponding to the MBMS dedicated cells and mixed cells. However, if a UE is equipped with single receiver, the UE may not be able to camp on a frequency layer supporting unicast services and receive the MBMS service on an MBMS dedicated frequency layer simultaneously. Therefore, the UE needs to move to an MBMS dedicated cell to receive the MBMS service distributed in an MBMS dedicated cell. In such case, when the UE is equipped with single receiver, in order to enable the UE in an MBMS dedicated cell to be notified when there is a mobile terminating call for the UE, the prior art provides location update procedures for the network to get location information of the UE, so as to perform paging in the MBMS dedicated cells.

In a prior art paging method, it is proposed that the UE performs location update upon the changes of tracking area by stopping receiving the current MBMS service and returning to a frequency layer supporting unicast services, so that the network knows where to page the UE. However, it's mandatory for the UE to leave the MBMS frequency layer to perform update, which will cause packet loss due to the break of the MBMS services or at least inconvenience of the procedure even though the procedure may be postponed to the end of the MBMS service session.

In another prior art paging method, the network pages all cells of last tracking area, which causes waste of system resources and failure of paging to last track area, for example, when the UE has not joined any MBMS services during the switching back to a unicast frequency layer or upon idle in MBMS dedicated frequency layer. In addition, it's also possible that the UE may leave those cells where the MBMS notifications have been issued.

Besides, in another prior art paging method, it provides the analysis of possible directions of considerations of the paging reception, and the UE will receive paging from the MBMS frequency layer and perform cell (re)selection to the unicast layer when a paging message is received. However, the main issued in this method would be the delayed paging response due to cell (re)selection to the unicast layer after the reception of paging. In addition, it didn't take further consideration of UEs' mobility with possible tracking area update. Moreover, it's an inconvincible assumption that a UE is mandatory to have a list of neighbouring cell list at all time, especially before performing cell (re)selection, due to possible mobility.

### SUMMARY OF THE INVENTION

According to the present invention, a method for enhancing paging efficiency in a wireless communications system comprises a user equipment of the wireless communications system receiving a service provided by a Multimedia Broadcast Multicast Service dedicated cell, and a network of the wireless communications system outputting a paging message for paging the user equipment in at least one cell of a tracking area determined according to a result of a tracking area update procedure of the user equipment when the network receives a terminating call corresponding to the user equipment.

According to the present invention, a communications device of a wireless communications system utilized for enhancing paging efficiency for avoiding radio resource waste comprises a control circuit for realizing functions of the communications device, a processor installed in the control circuit, for executing a program code to operate the control circuit, and a memory coupled to the processor for storing the program code. The program code comprises a user equipment of the wireless communications system receiving a service provided by a Multimedia Broadcast Multicast Service dedicated cell, and outputting a paging message for paging the user equipment in at least one cell of a tracking area determined according to a result of a tracking area update procedure of the user equipment when receiving a terminating call corresponding to the user equipment.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a function block diagram of a wireless communications device.

FIG. 2 is a diagram of program code of FIG. 1.

FIG. 3 and FIG. 4 are flowcharts of processes according to the embodiments of the present invention.

### DETAILED DESCRIPTION

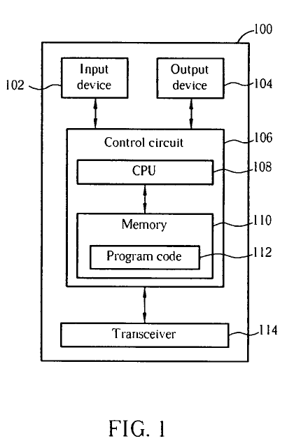

Please refer to FIG. 1, which is a functional block diagram of a communications device 100. For the sake of brevity, FIG. 1 only shows an input device 102, an output device 104, a control circuit 106, a central processing unit (CPU) 108, a memory 110, a program code 112, and a transceiver 114 of the communications device 100. In the communications device 100, the control circuit 106 executes the program code 112 in the memory 110 through the CPU 108, thereby controlling an operation of the communications device 100. The communications device 100 can receive signals input by a user through the input device 102, such as a keyboard, and can output images and sounds through the output device 104, such as a monitor or speakers. The transceiver 114 is used to receive and transmit wireless signals, delivering received signals to the control circuit 106, and outputting signals generated by the control circuit 106 wirelessly. From a perspective of a communications protocol framework, the transceiver 114 can be seen as a portion of Layer 1, and the control circuit 106 can be utilized to realize functions of Layer 2 and Layer 3. Preferably, the communications device 100 is utilized in a third generation (3G) mobile communications system.

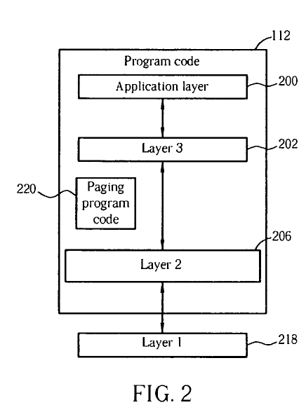

Please continue to refer to FIG. 2. FIG. 2 is a diagram of the program code 112 shown in FIG. 1. The program code 112 includes an application layer 200, a Layer 3 202, and a Layer 2 206, and is coupled to a Layer 1 218. The Layer 3 202 performs resource control, the Layer 2 206 performs link control, and the Layer 1 218 performs physical connections.

As mentioned above, when a UE is equipped with single receiver, in order to enable the UE in an MBMS dedicated cell to be notified when there is a mobile terminating call for the UE, the network performs paging in the MBMS dedicated cells. In such case, the embodiment of the present invention provides a paging program code 220 in the program code 112, utilized for realizing efficient and uninterrupting paging in LTE MBMS dedicated cell.

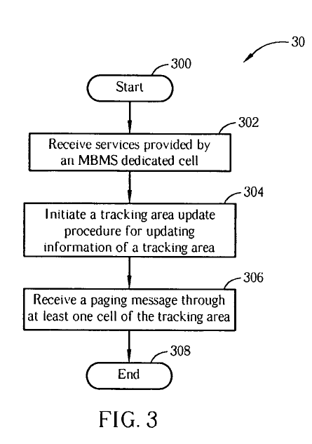

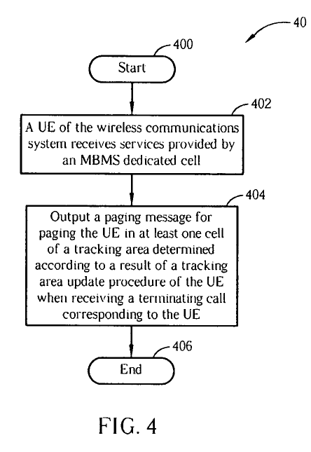

In order to implement the paging program code 220, the embodiment of the present invention provides processes for UE and network. Please refer to FIG. 3, and FIG. 4. FIG. 3 and FIG. 4 are flowcharts of processes 30 and 40 in accordance with the embodiments of the present invention. The process 30 is utilized for enhancing paging efficiency in a UE of a wireless communications system, and can be compiled into the paging program code 220. The process 30 comprises the following steps:
Step 300: Start.
Step 302: Receive services provided by an MBMS dedicated cell.
Step 304: Initiate a tracking area update procedure for updating information of a tracking area.
Step 306: Receive a paging message through at least one cell of the tracking area.
Step 308: End.

The process 40 is utilized in a network of a wireless communications system for enhancing paging efficiency, and can be compiled into the paging program code 220. The process 40 comprises the following steps:
Step 400: Start.
Step 402: A UE of the wireless communications system receives services provided by an MBMS dedicated cell.
Step 404: Output a paging message for paging the UE in at least one cell of a tracking area determined according to a result of a tracking area update procedure of the UE when receiving a terminating call corresponding to the UE.
Step 406: End.

According to the process 30 and 40, in the embodiment of the present invention, the UE or network entity initiates a tracking area update procedure when the UE receives services provided by an MBMS dedicated cell, so as to update information of the tracking area. Then, when the network receives a terminating call corresponding to the UE, the network can output a paging message for paging the UE in at least one cell of a tracking area according to the result of a tracking area update procedure of the UE. As a result, the network need not page all cells of last tracking area, so as to avoid system resource waste. Also, the UE need not stop receiving the current MBMS service, so as to prevent packet loss due to the break of the MBMS service.

Preferably, in the process 30, the UE performs an uplink transmission, for example, receives or uses system information, which can be sent with the paging message by the network or generated by the UE, for accessing an uplink transmission channel in the MBMS dedicated cell or a mixed cell, so as to perform the tracking area update procedure. Preferably, the UE can obtain a tracking area identity of the tracking area, which is allocated to the MBMS dedicated or the mixed cell and broadcasted by the network via a control channel. Preferably, the UE can use system information for outputting a response message through uplink transmission channel or a unicast cell selected from cell reselection procedure upon reception of the paging message or the terminating cal. The cell reselection procedure is performed by the UE before or upon reception of the paging message.

Preferably, in the process 40, the at least one cell belongs to a frequency layer dedicated to MBMS, and the network can output the paging message through a dedicated paging channel or a broadcasting channel. Preferably, the network can maintain a list corresponding to the UE, which comprise information, such as whether the user equipment enters a Multimedia Broadcast Multicast Service dedicated cell, whether the user equipment joins a Multimedia Broadcast Multicast Service services, and capability of the user equipment. As a result, the network can decide how to page the UE according to the list.

In the embodiment of the present invention, the downlink transmission of information through the MBMS dedicated frequency layer can be synchronized by the same means as synchronization at the transmission of paging messages. The uplink transmission can be implemented in a dedicated, or shared, or a random access channel. Furthermore, uplink synchronization, if necessary, can be achieved by using tracking area update timing to obtain the difference, if any or even during collision, of initial timing so as to be able to estimate the synchronization timing (for uplink in mixed cells).

In summary, embodiment of the present invention need not establish a list of neighbouring cell for reference of paging. Meanwhile, when the network receives a terminating call corresponding to the UE, the network need not page all cells of the last tracking area, so as to avoid system resource waste. Also, the UE need not stop receiving the current MBMS service, so as to prevent packet loss due to the break of the MBMS service.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for enhancing paging efficiency in a wireless communications system comprising:
a user equipment of the wireless communications system receiving a service provided by a Multimedia Broadcast Multicast Service dedicated cell; and
a network of the wireless communications system outputting a paging message for paging the user equipment in at least one cell of a tracking area determined according to a result of a tracking area update procedure of the user equipment when the network receives a terminating call corresponding to the user equipment.

2. The method of claim 1, wherein the tracking area update procedure is initiated by the user equipment or a network entity.

3. The method of claim 2, wherein the user equipment performs an uplink transmission for performing the tracking area update procedure.

4. The method of claim 3, wherein the user equipment receives or uses system information for accessing an uplink transmission channel for performing the uplink transmission.

5. The method of claim 4, wherein the uplink transmission channel is configured, scheduled or established in the Multimedia Broadcast Multicast Service dedicated cell or cells, or is configured, scheduled or established toward the head entity of MBMS cluster or the network entity.

6. The method of claim 4, wherein the uplink channel is configured, scheduled or established in a mixed cell supporting unicast services.

7. The method of claim 4, wherein the system information is sent with the paging message.

8. The method of claim 4, wherein the system information is generated by the network or maintained at the user equipment.

9. The method of claim 3, wherein a tracking area identity of the tracking area is obtained by the user equipment.

10. The method of claim 9, wherein the tracking area identity of the tracking area is broadcasted by the network via a control channel.

11. The method of claim 9, wherein the tracking area identity of the tracking area is allocated to the Multimedia Broadcast Multicast Service dedicated cell or a mixed cell.

12. The method of claim 1, wherein the at least one cell belongs to a frequency layer dedicated to Multimedia Broadcast Multicast Service.

13. The method of claim 12, wherein the network pages the user equipment through a dedicated paging channel or a broadcasting channel.

14. The method of claim 1 further comprising the network maintaining a list corresponding to the user equipment comprising at least information of whether the user equipment enters a Multimedia Broadcast Multicast Service dedicated cell, whether the user equipment joins certain Multimedia Broadcast Multicast Service services, or capability of the user equipment.

15. The method of claim 14 further comprising the network determining how to page the user equipment according to the list.

16. The method of claim 1, wherein the user equipment outputs a response message upon reception of the paging message or the terminating call.

17. The method of claim 16, wherein the user equipment outputs the response message through uplink transmission channel indicated by system information.

18. The method of claim 16, wherein the user equipment outputs the response message through a unicast cell selected from cell reselection procedure.

19. The method of claim 18, wherein the user equipment performs the cell reselection procedure upon or before receiving the paging message.

20. A communications device of a wireless communications system utilized for enhancing paging efficiency for avoiding radio resource waste comprising:
a control circuit for realizing functions of the communications device;
a processor installed in the control circuit, for executing a program code to operate the control circuit; and
a memory coupled to the processor for storing the program code;
wherein the program code comprises:
a user equipment of the wireless communications system receiving a service provided by a Multimedia Broadcast Multicast Service dedicated cell; and
outputting a paging message for paging the user equipment in at least one cell of a tracking area determined according to a result of a tracking area update procedure of the user equipment when receiving a terminating call corresponding to the user equipment.

21. The communications device of claim 20, wherein the tracking area update procedure is initiated by the user equipment or the communications device.

22. The communications device of claim 20, wherein the at least one cell belongs to a frequency layer dedicated to Multimedia Broadcast Multicast Service.

23. The communications device of claim 20, wherein the program code further comprises maintaining a list corresponding to the user equipment comprising information of whether the user equipment enters a Multimedia Broadcast Multicast Service dedicated cell, whether the user equipment joins a Multimedia Broadcast Multicast Service services, and capability of the user equipment.

24. The communications device of claim 20, wherein the user equipment outputs a response message upon reception of the paging message or the terminating call.
